(19) United States
(12) Patent Application Publication
(10) Pub. No.: US 2009/0308716 A1
(43) Pub. Date: Dec. 17, 2009

(54) Belt Conveyor

(75) Inventor: Sergio Marsetti, Castelli Calepio (Bergamo) (IT)

Correspondence Address: Cozen O''Connor, 250 PARK AVENUE, NEW YORK, NY, 10177, US

(73) Assignee: System Plast S.p.A., Telgate (Bergamo) (IT)

(21) Appl. No.: 12/137,002

(22) Filed: Jun. 11, 2008

(51) Int. Cl. B65G 23/18

(52) U.S. Cl. 198/805

(57) ABSTRACT

A belt conveyor comprising
a curved conveyor belt (1) comprising a plurality of modules (2) connected together by pins (3) and shaped such that the belt is able to travel through both straight and curved paths,
and a support and guide element or track (4) for said belt, comprising at least one curved portion (4A),
each module (2) comprising:
   a front end (2A) and a rear end (2B), an upper surface (2C) and a lower surface (2D), and two sides (2E, 2F),
   in which said front end (2A) and rear end (2B) comprise connection parts (5) comprising through holes (6), separated by apertures (7),
   said connection parts (5) being disposed such that those parts provided in the front end can be inserted into the apertures provided in the rear end (2B) of an adjacent module to enable a connection pin to be inserted through the through holes (6) of the connection parts (5) of the two modules to connect them together,
   and guide and connection means (3) for at least a plurality of the belt modules, with counter-means (8) provided in said belt support and slide element (4) at least at said curved portion (4A), to maintain the modules substantially in contact with said support and slide element (4) when the belt slides along said curved portion (4A), in said connection and guide means at least a part (3) of the modules (2) being made of a ferromagnetic material, and said counter-means comprising means to generate a magnetic field sufficient to maintain the modules (2) in contact with the support and slide element when the belt slides along said curved portion (4A).

The present invention relates to a belt conveyor in accordance with the precharacterising part of the main claim.

In the present context a belt conveyor means a conveyor, of which the belt-forming modules have their module-connecting members positioned at the front and rear ends of each module, such as to form a substantially parallelepiped flat bar element. A curved or side-flexing belt conveyor is defined as a belt conveyor, the modules of which are shaped and connected together in such a manner as to be able to travel through both straight and curved paths, a conveyor of this type being described for example in EP1306323 or EP427337.

For guiding the conveyor belt and maintaining it adhering to the relative slide track particularly through curves, currently known belt conveyors comprise coupling means generally presenting two prongs extending laterally from the lower surface of each belt module to cooperate with suitably shaped track parts, to hence form couplings, for example of the male-female or lug type (see for example the already stated EP1306323).

This type of mechanical connection between belt and the slide track is not totally satisfactory as it does not enable the belt to be raised from the track, for example to clean the track or replace one of the belt modules. A further drawback relates to the wear of the connection members between the module and track which, having to ensure adherence of the belt to the track, must be in continuous mutual contact.

It should be noted that although modular chain conveyors have been known for at least twenty years in which the modules are constrained to the track by magnetic attraction (see for example GB-A-2037690), no expert of the art has ever considered also using this type of solution in the conveyor belt field. In this respect, the expert of the art considers that this type of known solution for chains cannot be adapted to the belt field because the fact of making at least part of the belt modules of ferromagnetic material would make the belt too heavy, so that it would be subjected to excessive wear and deformation. Instead, it has been surprisingly found that even for belts a solution similar to that used for decades for chain conveyors can be used.

An object of the present invention is to provide a belt conveyor which overcomes the aforesaid drawbacks by enabling the belt modules to have a structure which is more simple and less subject to wear than the traditional modules, while ensuring optimal adherence to the slide track, in particular along the curves of said track.

This and other objects which will be apparent to the expert of the art are attained by a conveyor in accordance with the characterising part of the claims.

The present invention will be more apparent from the accompanying drawings, which are provided by way of non-limiting example and in which:

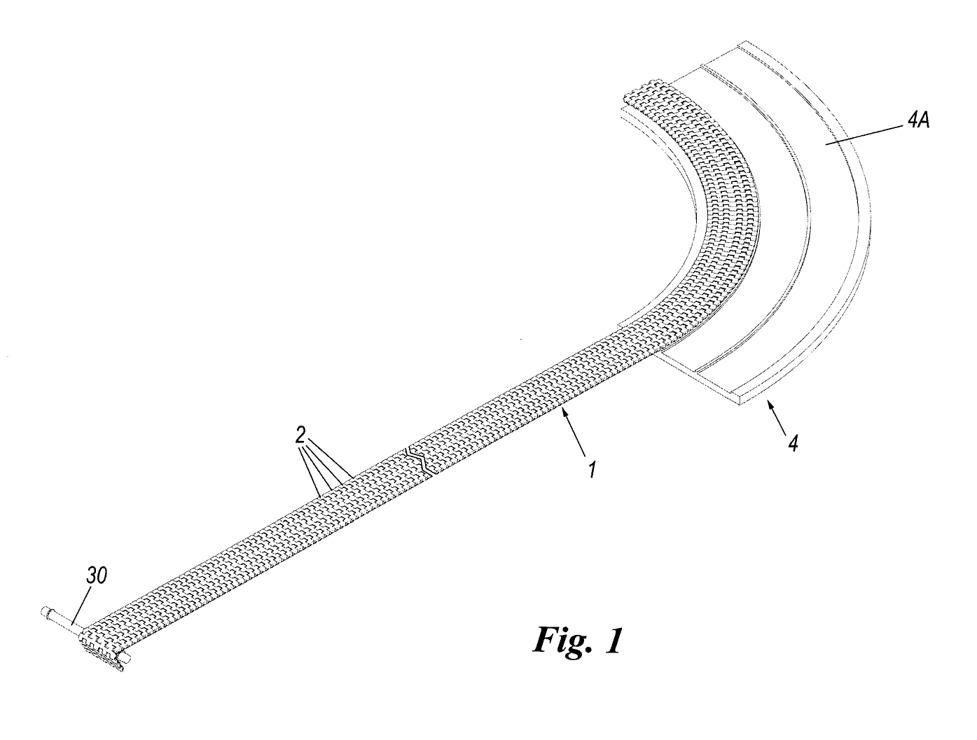

FIG. 1 is a schematic perspective view of a portion of a conveyor according to the invention,

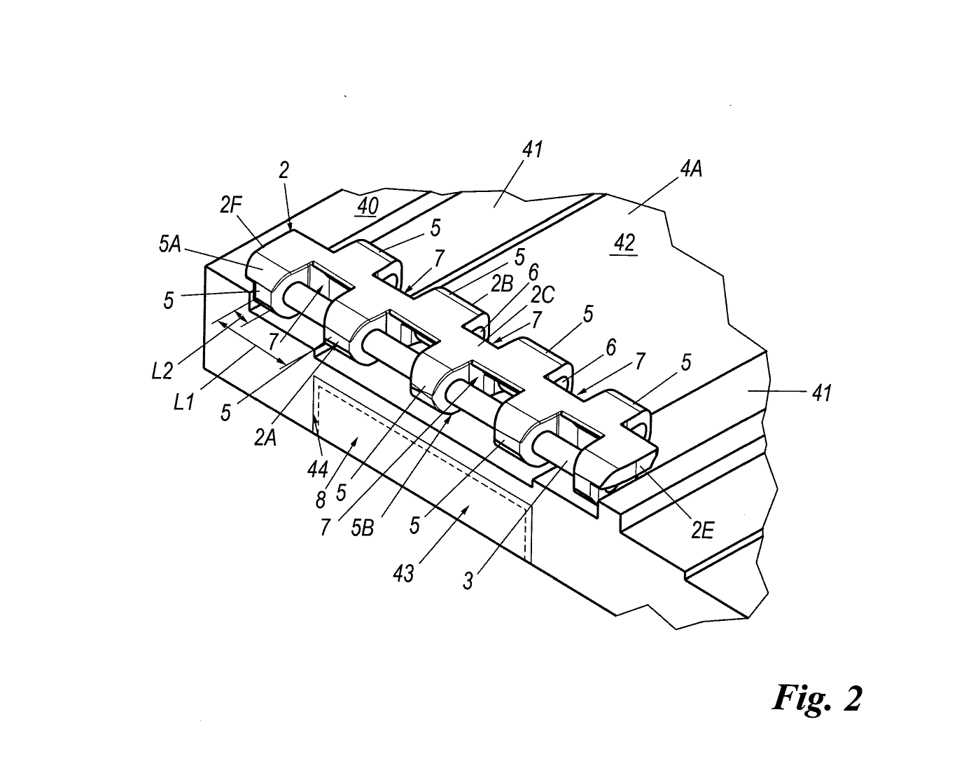

FIG. 2 is a schematic perspective view thereof showing a single module and a portion of a curved support and guide element,

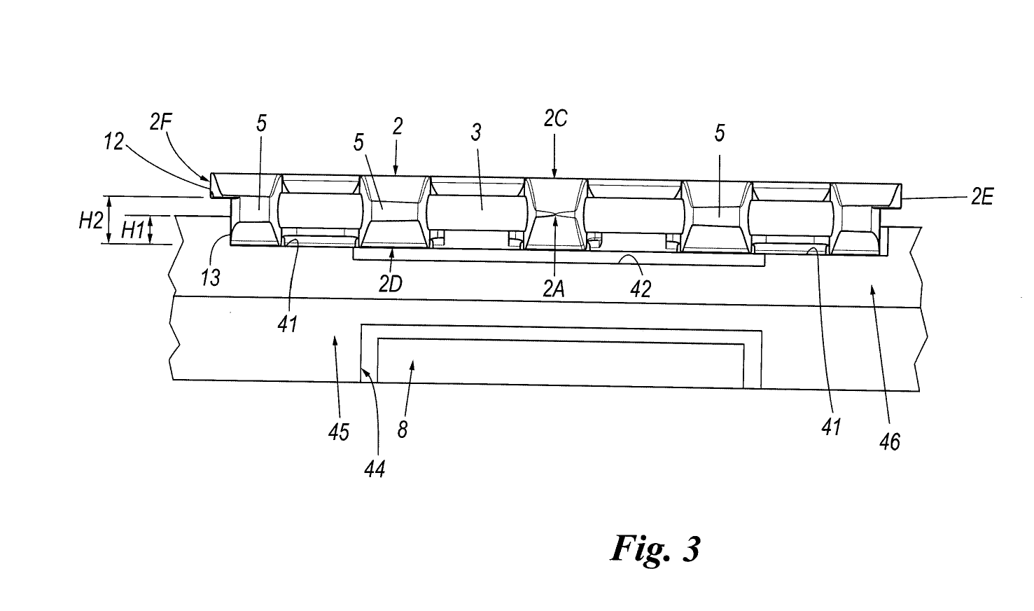

FIG. 3 is a front view thereof,

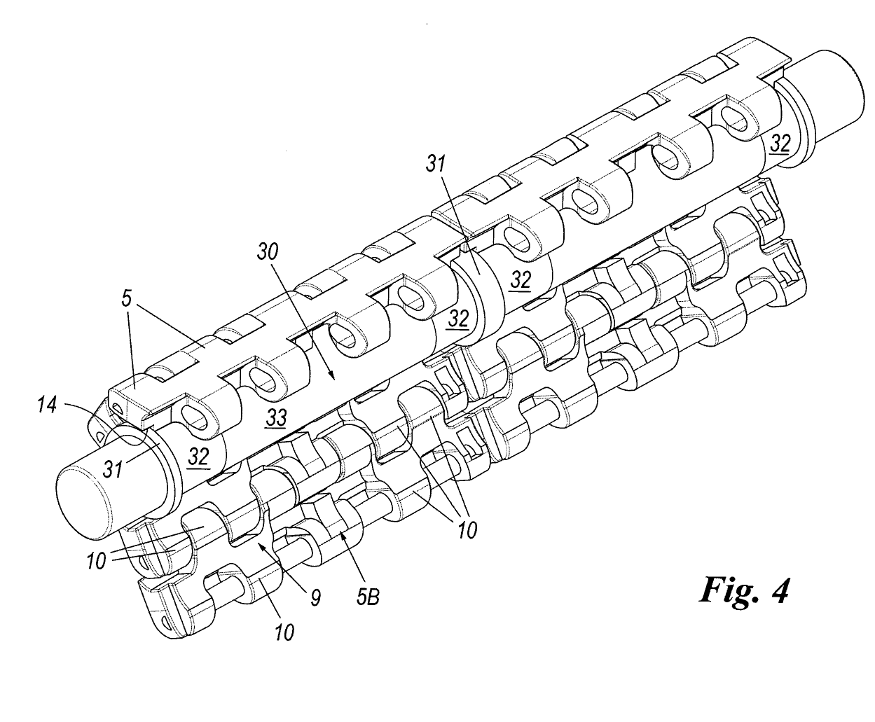

FIG. 4 is a schematic perspective view thereof showing a plurality of modules and a slide and guide roller,

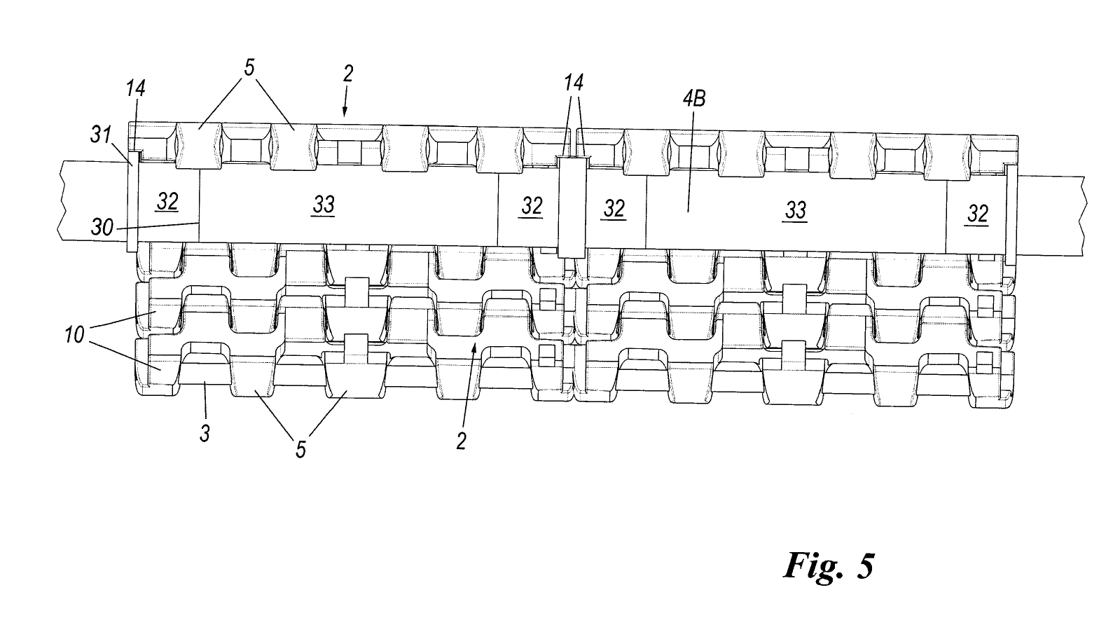

FIG. 5 is a front view thereof,

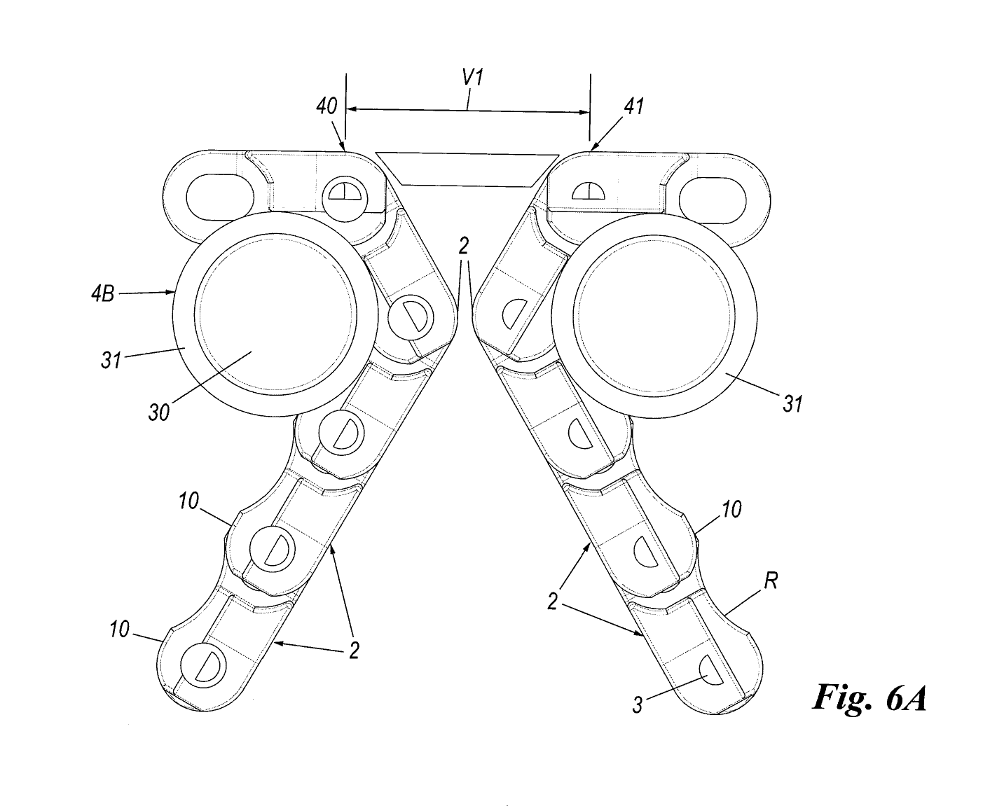

FIG. 6A is a schematic side view of two variants of two end parts of two mutually abutting conveyors,

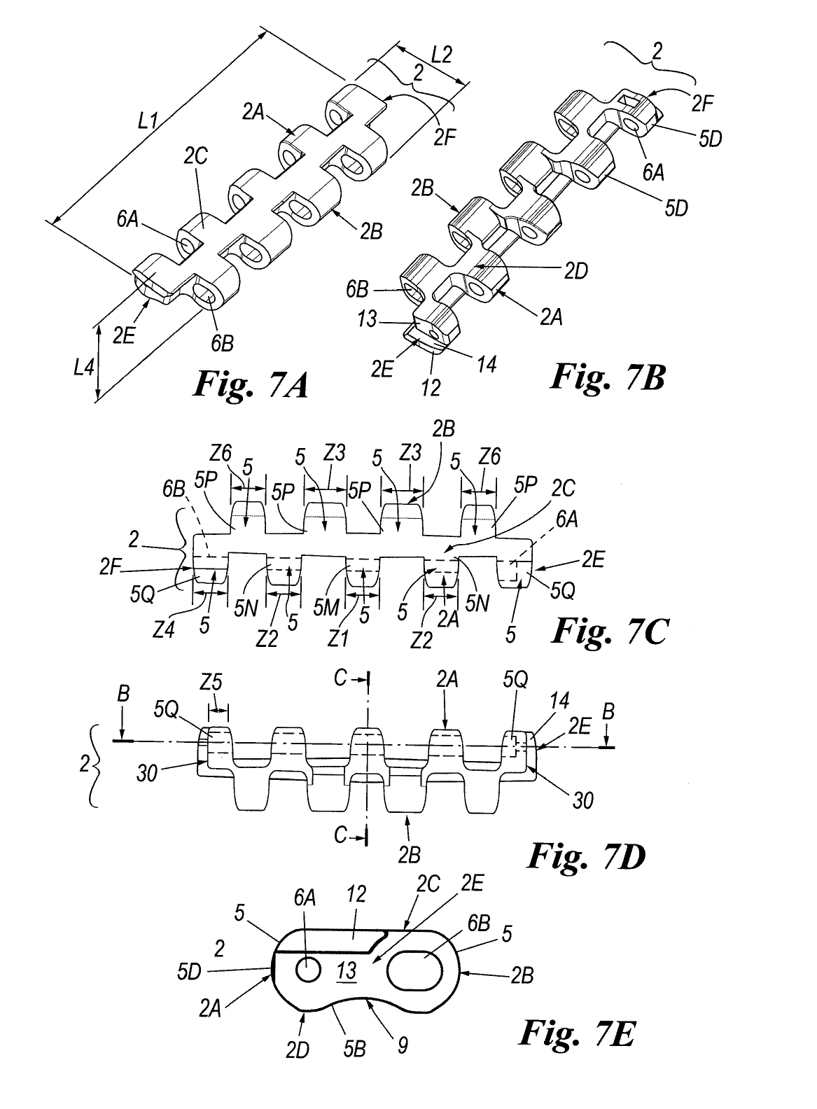

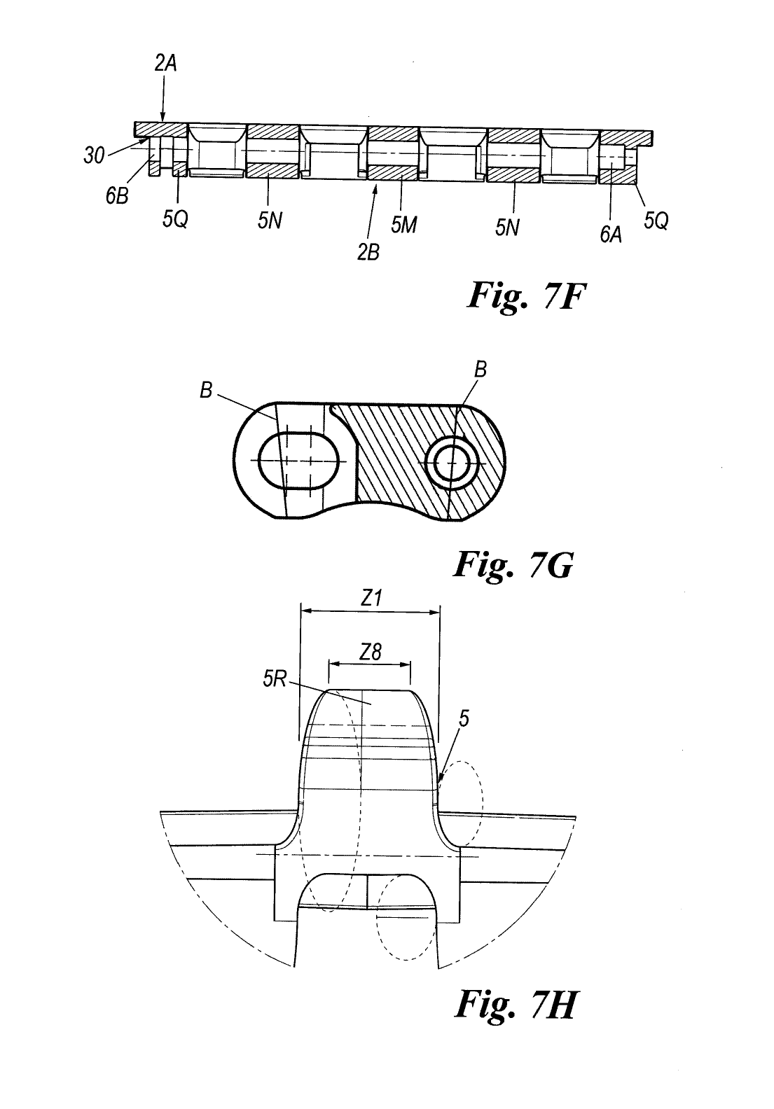

FIGS. 7A-H are schematic views of a module shown respectively in perspective view from above, in perspective view from below, from above, from below, from the side, on the sectional line BB of FIG. 7D, on the sectional line CC of FIG. 7D, and of the part indicated by D in FIG. 7D,

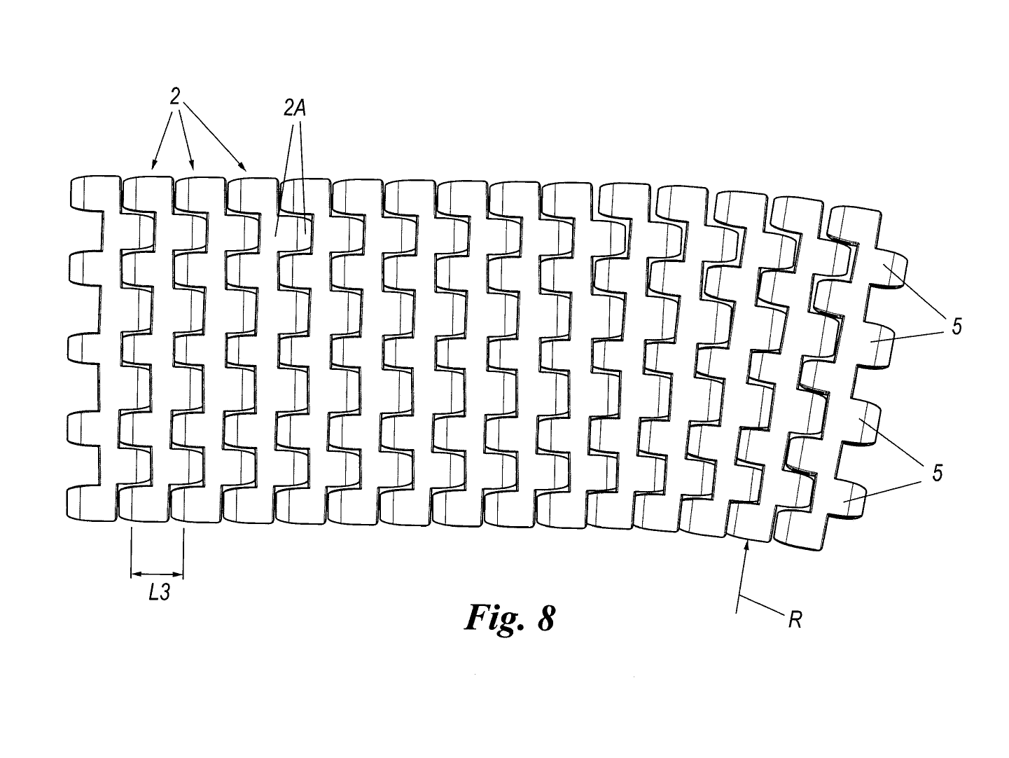

FIG. 8 is a view from above showing a portion of a conveyor moving along a straight initial path and a curved final path.

With reference to said figures, a continuous belt conveyor according to the invention comprises a conveyor belt 1 presenting a plurality of modules 2 connected together by pins 3, and a support and guide element or track 4 for said belt, comprising at least one curved portion 4A, and a return roller 30, in addition to usual belt slide and guide supports (not shown but conventional to the expert of the art).

Each module 2 comprises: a front end 2A and a rear end 2B, an upper surface 2C and a lower surface 2D, and two sides 2E. The front and rear ends 2A, B comprise connection parts 5 comprising through holes 6A, B separated by apertures 7, said parts 5 being disposed such that those parts provided in the front end of a module are inserted into the apertures provided in the rear end of an adjacent module such that a connection pin can be inserted through the through holes of the two module parts to connect them together.

As is conventional to the expert of the art, the holes provided in the front end 2A and rear end 2B of each module are different (the rear holes are slots while the front holes correspond to the cross-section through the pin 3) to enable the belt to be able to follow curved paths.

According to the invention, the connection pin between the modules is made of a ferromagnetic material, with the curved portion 4A of the belt slide track comprising permanent magnets 8 to generate a magnetic field such as to maintain the belt 1 in contact with the track 4 along its curved part 4A.

More specifically, the upper surface 2A of each belt module 2 is substantially flat and is arranged to form with the upper surfaces of the belt modules a substantially continuous flat resting surface (the open surfaces are less than or equal to 3%, preferably 2%) for the articles to be transported. This surface can comprise conventional surface treatments and/or usual elements secured to the surfaces to improve adherence of the articles to be transported and/or the surface characteristics. The upper surface could for example comprise a plurality of idle rollers supported by pins secured to prongs (not shown) extending from the side walls 2F, 2E.

As shown in FIGS. 7C, D, in order to improve the robustness of the modules and the size of their resting surface, the connection parts 5 do not all have the same shape and dimensions, in particular the central connection part 5M provided on the module front side 2A having a width Z1 less than the width Z2 of the adjacent parts 5N, the parts 5P provided on the other side 2B of the modules hence having a width Z3 greater than that of said parts 5M and 5N. The end parts 5Q of the module front surface 2A present a step 30 at the side surfaces, as described in detail hereinafter, consequently the upper surface of said parts has a width Z4 substantially equal to or slightly greater than the width Z2 of the adjacent parts 5N, whereas the lower surface has a lesser width Z5 to hence form the step 30. The end parts 5P of the module rear surface 2B have a width Z6 equal to the width Z2 of the parts 5N provided in the module front surface 2A. To improve module assembly, the connection parts 5 have their end part 5R slightly flared (as shown in FIG. 7H with reference to the part 5M), i.e. with a lesser width Z8 than the width Z1 of the remaining portion of said part 5.

Preferably as shown in FIG. 7C, the hole 6A provided in one of the end connection parts of the module front surface 2A is dead-ended while the hole 6B provided in the other end part is a through hole. By virtue of said holes 6 and 6A,B the connection pin 3 can also at least partially penetrate those parts 5 connection the modules together, provided in the most outer positions of said modules, and can extend for substantially the entire width of said modules.

Each of the connection parts 5 has a rounded end portion (FIG. 7E) partly involving the upper surface, the lower surface and the front and rear surfaces of the modules. Preferably, as shown in FIG. 7G, this rounded shape when viewed in cross-section is elliptical, with the ellipse major axis B inclined outwards. By this means, most of the upper surface of the connection parts 5 together forms a flat surface for the articles transported by the belt. The elliptical outline of those connection parts 5 provided at the front end 2A of the modules comprises an interruption given by a flat portion 5D.

At the lower surface 2D of each module the connection parts 5 have a substantially curved outline with a flat bevelled apex portion forming a small-dimension flat surface enabling the modules to slide on the relative support track.

Advantageously, the lower surface 5B of each module has an undulated shape given by the rounding of the connection parts 5 and by a central portion 9 of the modules recessed for lightening purposes and presenting an arcuate profile. The effective lower resting surface, which slides on the track, is however limited, as already indicated, by the mutually copolanar flat bevelled apex portions of the connection parts 5. The module sides 3E, 2F are divided (FIG. 3) into an upper 12 and lower 13 vertical portion, the upper portion of which extends outwards from the lower portion to hence form a step and define a horizontal wall 14. According to the invention, the slide track 4 and in particular its curved portion 4A is shaped such that the horizontal wall 14 of the side walls 2F, 2E does not come into contact with the track upper surface 40, hence reducing friction and wear of the belt modules. For this purpose the height H1 (FIG. 3) of that part of the track 4 on which the belt modules slide is less than the height H2 of the horizontal wall 14 of the end walls of each module.

To further reduce wear and friction the slide track 4 and in particular its curved portion 4A presents in its lower surface a hollow portion 42 defining two lateral sub-tracks 41 on which the modules slide. These lateral tracks advantageously have a width L1 (FIG. 2) greater than that L2 of the part in contact with the tracks of the connection parts 5 provided at the module ends, but less than double this width L2, such that L2<L1<2L2.

Advantageously, the curved portion 4A of the track is formed in a suitably shaped single piece 43, comprising the two sub-tracks 41 connected together by the recessed part 42 with, in its lower face, a plurality of lowerly open recessed seats 44 (FIG. 2) to house the permanent magnets 8 which generate a magnetic field such as to maintain the belt 1 in contact with the track 4A. The permanent magnets are preferably housed in conventional containers removably fixed into the seats 44, for example by screws 44.

Alternatively (FIG. 3), the curved track 4A comprises a body 46 with a thin base such as not to be able to accommodate the seats 44 for the magnets, however with this solution an additional piece 45 is removably fixed to the track lower surface for example by screws, with its lower face being provided with the seats 4 for the magnets 8. In this manner the track can be made of two materials of different resistance to the stresses deriving from the sliding of the belt, and hence of different costs.

Likewise according to a further variant, not shown, the curved track 4A is made of a plurality of parts of different materials, for example the parts on which the belt slides being of a first material and the parts which do not come into contact with the belt being of a second material, less valuable than the first and hence less costly. Said parts can be co-moulded or glued together to form a single body, or be removably fixed together, for example by screws.

The guide rollers 30 provided at the conveyor ends also comprise circular relief elements 31 of height such as not to come into contact with the flat surface 14 of the end connection parts 5 of each belt module. Advantageously, the rollers 30, as in the case of the curved track 4A, also comprise a recessed central part 33 to limit the sliding of the belt to just the end portions 32.

Advantageously the length L1 (FIG. 7A) of each module is less than or equal to 85 mm, preferably 83.8 mm, its width L2 being less than or equal to 25 mm, preferably 20.6 mm, with the distance L3 (FIG. 8) between the two pins of a module being less than or equal to 16 mm, preferably 12.7 mm, and its height L4 being less than or equal to 13 mm, preferably 8.7 mm. In this manner single or side-by-side belts can be formed having a high load-carrying capacity, while at the same time when two conveyors are mutually abutting (FIG. 6) they enable the distance VI between the end 40 of the load-carrying surface for the products transported by one conveyor and the beginning 41 of the load-carrying surface of the tail-end conveyor to be limited to values less than 25 mm, preferably 18 mm, enabling curved paths to be followed, with radii of curvature R (FIG. 8) of the order of 500 mm.

Finally it should be noted that the aforedescribed embodiment has been provided by way of example only, and that numerous variants are possible, all falling within the same inventive concept, for example instead of providing module connection pins 3 of ferromagnetic material, a different part of the modules could be of ferromagnetic material, or they could be formed of a plastic material with incorporated ferromagnetic material, for example in powder form.

Likewise to generate the magnetic field, magnetic means different from the aforedescribed permanent magnets could be used, but still of conventional type to the expert of the art.

1. A belt conveyor comprising
a curved conveyor belt (1) comprising a plurality of modules (2) connected together by pins (3) and shaped such that the belt is able to travel through both straight and curved paths,
and a support and guide element or track (4) for said belt, comprising at least one curved portion (4A),
each module (2) comprising:
a front end (2A) and a rear end (2B), an upper surface (2C) and a lower surface (2D), and two sides (2E, 2F),
in which said front end (2A) and rear end (2B) comprise connection parts (5) comprising through holes (6), separated by apertures (7),
said connection parts (5) being disposed such that those parts provided in the front end can be inserted into the apertures provided in the rear end (2B) of an adjacent module to enable a connection pin to be inserted through the through holes (6) of the connection parts (5) of the two modules to connect them together and enable one module to at least partially rotate relative to the next, said pin being provided above a surface (10) by which said modules slide on said support element or track (4), and extends substantially from one to the other of said module sides (2E, F),
and guide and connection means (3) for at least a plurality of the belt modules, with counter-means (8) provided in said belt support and slide element (4) at least at said curved portion (4A), to maintain the modules substantially in contact with said support and slide element (4) when the belt slides along said curved portion (4A),
characterised in that
in said connection and guide means at least a part (3) of the modules (2) is made of a ferromagnetic material, said counter-means comprising means to generate a magnetic field sufficient to maintain the modules (2) in contact with the support and slide element when the belt slides along said curved portion (4A).

2. A conveyor as claimed in claim 1, characterised in that that module part made of ferromagnetic material is the module connection pin (3).

3. A conveyor as claimed in claim 1, characterised in that the counter-means for generating a magnetic field are permanent magnets (8).

4. A conveyor as claimed in claim 1, characterised in that the curved portion (4A) of the slide track (4) has that surface in contact with the belt formed from lateral sub-tracks (41) separated from each other by an aperture or a recessed central portion such as to limit said contact surface.

5. A conveyor as claimed in claim 4, characterised in that the width (L1) of the sub-tracks (41) is greater than the width (L2) of the part in contact with the sub-tracks of the connection parts (5) provided at the module ends, but less than double said width (L2) of said parts.

6. A conveyor as claimed in claim 1, characterised in that the lower surface (2D) of each module is a surface having an undulated shape to hence limit the surface making contact with the slide track to a substantially flat apex portion (10) of said undulated surface.

7. A conveyor as claimed in claim 1, characterised in that the sides (2E, F) of each module are divided into an upper portion (12) and a lower portion (13), the upper portion extending outwards to form a step and define a substantially horizontal wall (14).

8. A conveyor as claimed in claim 7, characterised in that the slide track (4) and in particular its curved portion (4A) is shaped such that the horizontal wall (14) of the module sides (2F, 2E) does not make contact with the upper surface (40) of said track, to hence reduce the friction and wear of the belt modules.

9. A conveyor as claimed in claim 8, characterised in that the height (H1) of that part of the track (4) on which the belt modules slide is less than the height (H2) of the horizontal wall (14) of the module sides (2E, F).

10. A conveyor as claimed in claim 1, characterised in that the curved portion (4A) of the slide track (4) is formed in one piece (43), comprising the two sub-tracks (41) connected together by a recessed part (42) which does not make contact with the modules, said piece presenting, in its lower face at said recessed part, a plurality of lowerly open seats (44) to house the magnetic means (8).

11. A conveyor as claimed in claim 1, characterised in that the support and guide element (4) comprises guide rollers (30) provided at the conveyor ends, said rollers comprising circular relief elements (31) having a height such as not to come into contact with the flat surface (14) of the end connection parts (5) of each belt module.

12. A conveyor as claimed in claim 1, characterised in that the support and guide element (4) comprises guide rollers (30) provided at the conveyor ends, said rollers having a recessed central part such as to limit belt sliding to only the end portions (32).

13. A conveyor as claimed in claim 1, characterised in that the connection parts (S) are of different shapes and dimensions one from another, the central connection part (5M) provided on the module front side (2A) having a width (Z1) less than the width (Z2) of the adjacent parts (5N), the parts (5P) provided on the other end (2B) of the modules hence having a width (Z3) greater than that of said parts (5M, 5N).

14. A conveyor as claimed in claim 1, characterised in that the connecting end parts (5Q) of the module front surface (2A) present at their side surfaces a step (30) forming for said parts an upper surface having a width (Z4) substantially equal to or slightly greater than the width (Z2) of the adjacent parts (5N), and a lower surface having a lesser width (Z5).

15. A conveyor as claimed in claim 1, characterised in that the end connection parts (5P) of the module rear end (2B) have a width (Z6) equal to the width (Z2) of the parts (5N) provided to the sides of the central part (5M) in the module front end (2A).

16. A conveyor as claimed in claim 1, characterised in that the connection parts (5) have their end part (5R) slightly flared, i.e. with a width (Z8) decreasing relative to the width (Z1) of the remaining portion of said part (5).

17. A conveyor as claimed in claim 1, characterised in that the connection parts (5) have a rounded end portion partly involving the upper surface, the lower surface and the front and rear surfaces of the modules, said rounded pattern when viewed in cross-section being elliptical with the ellipse major axis (B) inclined outwards.

18. A conveyor as claimed in claim 1, characterised in that the length (L1) of each module is less than or equal to 85 mm, preferably 83.8 mm, and/or its width (L2) is less than or equal to 25 mm, preferably 20.6 mm, and/or the distance (L3) between the two pins of a module is less than or equal to 16 mm, preferably 12.7 mm, and/or its height (L4) is less than or equal to 13 mm, preferably 8.7 mm.

19. A modular element for a belt conveyor comprising:
a curved conveyor belt (1) comprising a plurality of said modular elements (2) connected together by pins (3) and shaped such that the belt is able to travel through both straight and curved paths,
and a support and guide element or track (4) for said belt, comprising at least one curved portion (4A),
each modular element (2) comprising:
a front end (2A) and a rear end (2B), an upper surface (2C) and a lower surface (2D), and two sides (2E, 2F),
in which said front end (2A) and rear end (2B) comprise connection parts (5) comprising through holes (6), separated by apertures (7),
said connection parts (5) being disposed such that those parts provided in the front end can be inserted into the apertures provided in the rear end (2B) of an adjacent modular element to enable a connection pin to be inserted through the through holes (6) of the connection parts (5) of the two modular elements to connect them together and enable one module to at least partially rotate relative to the next, said pin being provided above a surface (10) by which said modules slide on said support element or track (4), and extends substantially from one to the other of said module sides (2E, F),
and guide and connection means (3) for at least a plurality of the belt modular elements, with counter-means (8) provided in said belt support and slide element (4) at least at said curved portion (4A), to maintain the modular elements substantially in contact with said support and slide element (4) when the belt slides along said curved portion (4A),
characterised in that
in said connection and guide means at least a part (3) of the modular elements (2) is made of a ferromagnetic material, said counter-means comprising means to generate a magnetic field sufficient to maintain the modules (2) in contact with the support and slide element when the belt slides along said curved portion (4A).

20. A modular element as claimed in claim 19, characterised in that that module part made of ferromagnetic material is the module connection pin (3).

21. A modular element as claimed in claim 19, characterised in that the lower surface (2D) of each module is a surface having an undulated shape to hence limit the surface making contact with the slide track to a substantially flat apex portion (10) of said undulated surface.

22. A modular element as claimed in claim 19, characterised in that the sides (2E, F) are divided into an upper portion (12) and a lower portion (13), the upper portion extending outwards from the lower portion to form a step and define a substantially horizontal wall (14).

23. A modular element as claimed in claim 19, characterised in that the connection parts (5) are of different shapes and dimensions one from another, the central connection part (5M) provided on the module front side (2A) having a width (Z1) less than the width (Z2) of the adjacent parts (5N), the parts (5P) provided on the other end (2B) of the modules hence having a width (Z3) greater than that of said parts (5M, 5N).

24. A modular element as claimed in claim 19, characterised in that the connecting end parts (5Q) of the module front surface (2A) present at the side surfaces a step (30) forming for said parts an upper surface having a width (Z4) substantially equal to or slightly greater than the width (Z2) of the adjacent parts (5N), and a lower surface having a lesser width (Z5).

25. A modular element as claimed in claim 19, characterised in that the end connection parts (5P) of the module rear end (2B) have a width (Z6) equal to the width (Z2) of the parts (5N) provided to the sides of the central part (5M) in the module front end (2A).

26. A modular element as claimed in claim 19, characterised in that the connection parts (5) have their end part (5R) slightly flared, i.e. with a width (Z8) decreasing relative to the width (Z1) of the remaining portion of said part (5).

27. A modular element as claimed in claim 19, characterised in that the connection parts (5) have at their end portion a rounded shape partly involving the upper surface, the lower surface and the front and rear surfaces of the modules, said rounded shape when viewed in cross-section being elliptical with the ellipse major axis (B) inclined outwards.

28. A modular element as claimed in claim 19, characterised in that the length (L1) of each module is less than or equal to 85 mm, preferably 83.8 mm, and/or its width (L2) is less than or equal to 25 mm, preferably 20.6 mm, and/or the distance (L3) between the two pins of a module is less than or equal to 16 mm, preferably 12.7 mm, and/or its height (L4) is less than or equal to 13 mm, preferably 8.7 mm.

29. A support element for
a curved conveyor belt (1) comprising a plurality of modules (2) connected together by pins (3) and shaped such that the belt is able to travel through both straight and curved paths,
said support element comprising at least one curved portion (4A),
each module (2) comprising:
a front end (2A) and a rear end (2B), an upper surface (2C) and a lower surface (2D), and two sides (2E, 2F),
in which said front end (2A) and rear end (2B) comprise connection parts (5) comprising through holes (6), separated by apertures (7),
said connection parts (5) being disposed such that those parts provided in the front end can be inserted into the apertures provided in the rear end (2B) of an adjacent module to enable a connection pin to be inserted through the through holes (6) of the connection parts (5) of the two modules to connect them together and enable one module to at least partially rotate relative to the next, said pin being provided above a surface (10) by which said modules slide on said support element or track (4), and extends substantially from one to the other of said module sides (2E, F),
and guide and connection means (3) for at least a plurality of the belt modules, with counter-means (8) provided in said belt support and slide element (4) at least at said curved portion (4A), to maintain the modules substantially in contact with said support and slide element (4) when the belt slides along said curved portion (4A),
characterised in that
in said connection and guide means at least a part (3) of the modules (2) is made of a ferromagnetic material, said counter-means comprising means to generate a magnetic field sufficient to maintain the modules (2) in contact with the support and slide element when the belt slides along said curved portion (4A).

30. An element as claimed in claim 29, characterised in that the counter-means for generating a magnetic field are permanent magnets (8).

31. An element as claimed in claim 29, characterised in that the curved portion (4A) presents a recessed or empty central part (42) such as to limit its contact surface with the belt to lateral sub-tracks (41).

32. An element as claimed in claim 31, characterised in that the width (L1) of the sub-tracks (41) is greater than the width (L2) of the part in contact with the sub-tracks of the connection parts (5) provided at the module ends, but less than double said width (L2) of said parts.

33. An element as claimed in claim 29, characterised by being shaped such that a horizontal wall (14) of the module sides (2F, 2E) does not make contact with the upper surface (40) of said track, to hence reduce the friction and wear of the belt modules.

34. An element as claimed in claim 33, characterised in that the height (H1) of that part of the track (4) on which the belt modules slide is less than the height (H2) of the horizontal wall (14) of the module sides (2E, F).

35. An element as claimed in claim 29, characterised in that the curved portion (4A) of the slide track (4) is formed in one piece (43), comprising the two sub-tracks (41) connected together by a recessed part (42) which does not make contact with the modules, said piece presenting, in its lower face at said recessed part, a plurality of lowerly open seats (44) to house the magnetic means (8).

36. An element as claimed in claim 1, 19 or 29, characterised by comprising guide rollers (30) provided at the conveyor ends, said rollers comprising circular relief elements (31) having a height such as not to come into contact with the flat surface (14) of the end connection parts (5) of each belt module.

37. An element as claimed in claim 1, 19 or 29, characterised by comprising guide rollers (30) provided at the conveyor ends, said rollers having a recessed central part such as to limit belt sliding to only the end portions (32).
